(19) United States
(12) Patent Application Publication
(10) Pub. No.: US 2026/0050417 A1
(43) Pub. Date: Feb. 19, 2026

(54) TECHNIQUES FOR GENERATING CODE FROM NATURAL LANGUAGE INSTRUCTIONS USING MULTI-AGENT FRAMEWORK

(71) Applicant: NVIDIA CORPORATION, Santa Clara, CA (US)

(72) Inventors: Yunsheng BAI, Mountain View, CA (US); Ghaith Bany HAMAD, San Jose, CA (US); Chia-Tung HO, Santa Clara, CA (US); Haoxing REN, Austin, TX (US); Jiaxin WAN, Santa Clara, CA (US)

(21) Appl. No.: 19/201,767

(22) Filed: May 7, 2025

Related U.S. Application Data
(60) Provisional application No. 63/682,654, filed on Aug. 13, 2024.

(51) Int. Cl. G06F 8/33

(52) U.S. Cl. CPC G06F 8/33

(57) ABSTRACT

A computer-implemented technique for generating program code includes receiving a first natural language instruction; extracting, from an improvement knowledge data set based on the first natural language instruction, one or more first improvement knowledge examples, where each improvement knowledge example included in the one or more first improvement knowledge examples comprises one or more learned rules for generating program code; and generating, via a trained language model, first program code based on the first natural language instruction and the first one or more improvement knowledge examples.

### CROSS-REFERENCE TO RELATED APPLICATIONS

This application claims priority benefit of the United States Provisional Patent Application titled, “Multi-Agent Framework for Formal Verification Assertion Generation from Natural Language Specifications,” filed on Aug. 13, 2024, and having Ser. No. 63/682,654. The subject matter of this related application is hereby incorporated herein by reference.

### BACKGROUND

### Field of the Various Embodiments

The various embodiments relate generally to computer science, artificial intelligence (AI), and machine learning and, more specifically, to techniques for generating code from natural language instructions using a multi-agent framework.

### Description of the Related Art

In machine learning, language models are one type of machine learning model that generate text. Language models have become increasingly capable of performing various natural language processing tasks. Large language models (LLMs) are one type of language model. Conventionally, an LLM is implemented as a neural network that includes a large number (e.g., billions) of parameters and is trained on a large quantity of text data.

Once trained, an LLM is oftentimes able to perform a wide variety of natural language processing tasks. One natural language processing task that a trained LLM can perform is code generation. Code generation is the process of automatically generating program code given an input, such as natural language text. For example, an LLM can be prompted to generate a SystemVerilog Assertion (SVA) for verifying that an integrated circuit operates as designed. SVAs are formal statements that specify design behaviors using temporal logic. SVAs are used to check design rules or specifications and generate warnings or errors in case of assertion failures. SVAs can be input into formal verification tools, which exhaustively test the SVAs against designs of integrated circuits.

One drawback of conventional language models, and conventional LLMs in particular, is that these models sometimes generate incorrect program code that cannot be successfully compiled and executed. Returning to the SVA example, a conventional LLM could generate, from a natural language input, an SVA that is unable to be compiled and executed by formal verification tools.

As the foregoing illustrates, what is needed in the art are more effective techniques for generating program code using language models.

### SUMMARY

One embodiment of the present disclosure sets forth a computer-implemented method for generating program code. The method includes receiving a first natural language instruction. The method further includes extracting, from an improvement knowledge data set based on the first natural language instruction, one or more first improvement knowledge examples, where each improvement knowledge example included in the one or more first improvement knowledge examples comprises one or more learned rules for generating program code. In addition, the method includes generating, via a trained language model, first program code based on the first natural language instruction and the one or more first improvement knowledge examples.

One embodiment of the present disclosure sets forth a computer-implemented method for generating text. The method includes generating first improvement knowledge based on reflection, by a trained machine learning model, on one or more errors in first text generated from a first natural language instruction. The method further includes storing the first improvement knowledge in an improvement knowledge data set. In addition, the method includes generating second text based on a second natural language instruction and one or more examples of improvement knowledge extracted from the improvement knowledge data set.

At least one technical advantage of the disclosed techniques relative to the prior art is that improvement knowledge is self-learned for use in generating text, such as program code. When program code is generated, the disclosed techniques automatically verify and correct errors in the program code. Accordingly, more accurate text, including program code, can be generated for an input natural language instruction relative to what can be generated using prior art approaches. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of at least one embodiment;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the training application of FIG. 1, according to various embodiments;

FIG. 5 illustrates an exemplar prompt for self-reflection and generating improvement knowledge, according to various embodiments;

FIG. 6 is a more detailed illustration of the code generator of FIG. 1, according to various embodiments;

FIG. 7 illustrates how the adaptive learning agent of FIG. 6 extracts improvement knowledge examples for use in generating code, according to various embodiments;

FIG. 8 illustrates an exemplar prompt for reasoning and pruning when generating improvement knowledge examples, according to various embodiments;

FIG. 9 illustrates an exemplar prompt for generating code, according to various embodiments;

FIG. 10 illustrates how the syntax correction agent of FIG. 6 corrects generated code, according to various embodiments;

FIG. 11 illustrates an exemplar prompt for correcting generated code, according to various embodiments;

FIG. 12 is a flow diagram of method steps for performing training to generate improvement knowledge data, according to various embodiments;

FIG. 13 is a flow diagram of method steps for generating code, according to various embodiments;

FIG. 14 is a flow diagram of method steps for extracting improvement knowledge examples, according to various embodiments; and

FIG. 15 is a flow diagram of method steps for correcting generated code, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

### General Overview

Embodiments of the present disclosure provide techniques for generating text, such as program code, from natural language instructions. In some embodiments, a code generator application implements a multi-agent framework that uses an experience retrieval agent, an adaptive learning agent, and a syntax correction agent to translate a natural language instruction that is received as input into program code. The experience retrieval agent retrieves, from an experience data set, experience examples of translating natural language experiences into code that are relevant to the input natural language instruction. The adaptive learning agent extracts examples of improvement knowledge, generated through self-learning, that are relevant to the input natural language instruction. The code generator generates a prompt that includes the input natural language instruction, the experience examples, and the improvement knowledge examples into a language model. Given such a prompt, the language model generates program code. The syntax correction agent uses a code verification tool to check the generated code for syntactic correctness, and the syntax correction agent prompts the language model to re-generate the code when syntax errors are identified.

A training application uses the adaptive learning agent to generate an improvement knowledge data set, from which improvement knowledge examples can be extracted during code generation. For each pair of natural language instruction and corresponding reference code from a training data set, the adaptive learning agent iteratively prompts a language model to generate code according to the natural language instruction. At each iteration, the adaptive learning agent compares the generated code with the reference code to identify functional and/or syntactic errors. Then, the adaptive learning agent prompts the language model to reflect on the errors, if any, and generate improvement knowledge that includes one or more rules for more accurately generating code for the natural language instruction. The iteration process repeats until the language model generates code that is syntactically correct and functionally identical to the reference code or a maximum number of iterations is reached, after which the latest improvement knowledge is saved in the improvement knowledge data.

The techniques for generating text have many real-world applications. For example, these techniques can be used to generate program code, such as System Verilog assertions (SVA) for verifying that integrated circuits operate as designed. As a further example, these techniques can be used to generate text that does not include program code, for other natural language processing tasks.

The above examples are not in any way intended to be limiting. As persons skilled in the art will appreciate, as a general matter, the techniques for generating text that are described herein can be implemented in any application where generating program text is required or useful.

### System Overview

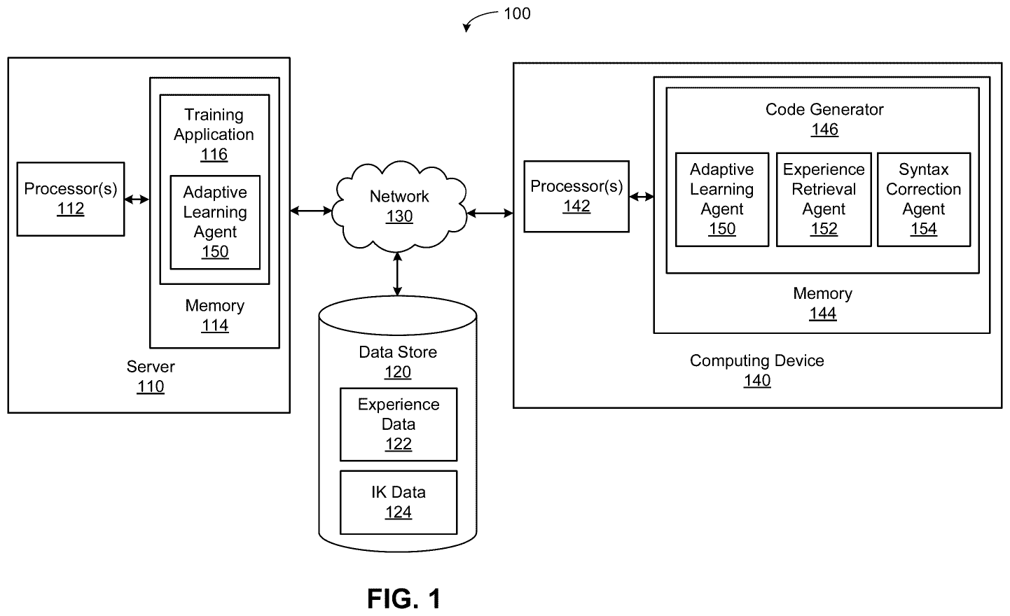

FIG. 1 illustrates a block diagram of a computer-based system 100 configured to implement one or more aspects of at least one embodiment. As shown, the system 100 includes, without limitation, a server 110, a data store 120, and a computing device 140 in communication over a network 130, which can include a wide area network (WAN) such as the Internet, a local area network (LAN), a cellular network, and/or any other suitable network or networks.

As shown, a training application 116 executes on one or more processors 112 of the server 110 and is stored in a system memory 114 of the server 110. The processor(s) 112 receive user input from input devices, such as a keyboard or a mouse. In operation, the one or more processors 112 may include one or more primary processors of the server 110, such as one or more central processing units (CPUs), controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor(s) 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

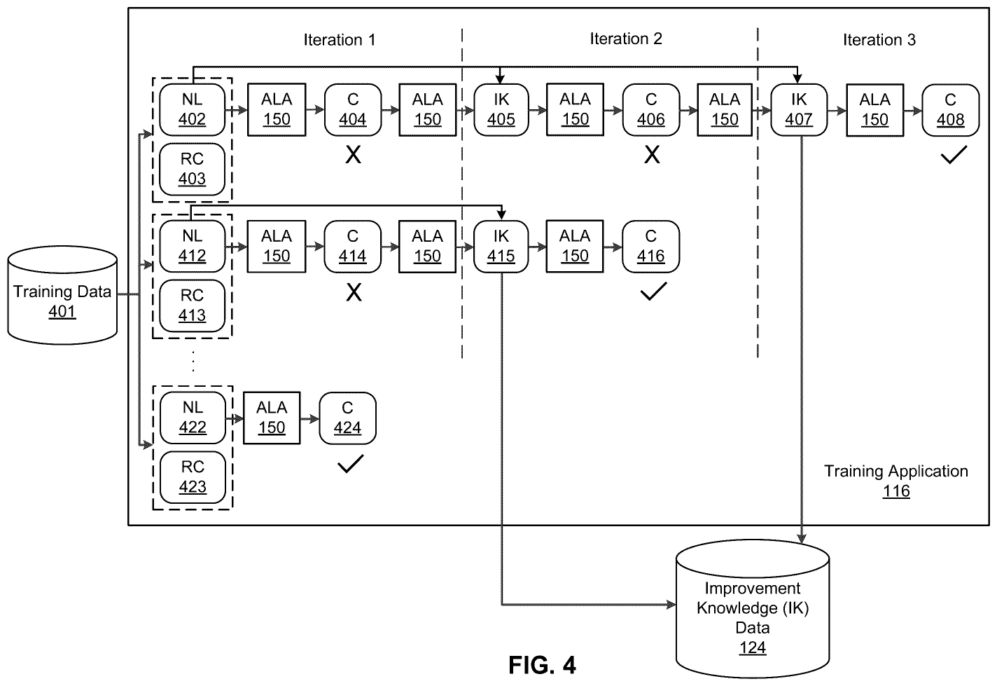

In some embodiments, the training application 116 is configured to perform training using an adaptive learning agent 150 to generate an improvement knowledge (IK) data set 124 (also referred to herein as “improvement knowledge data 124”) that includes rules for accurately generating code from natural language instructions. Details of the training application 116 are discussed in greater detail below in conjunction with FIGS. 4-5 and 12. Once generated, the improvement knowledge data 124 can be stored in the data store 120 or elsewhere (e.g., a storage device of computing device 140). In addition, experience data 122 that includes examples of translating natural language instructions to program code can also be stored in the data store 120 or elsewhere (e.g., a storage device of computing device 140). In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the server 110 can include the data store 120.

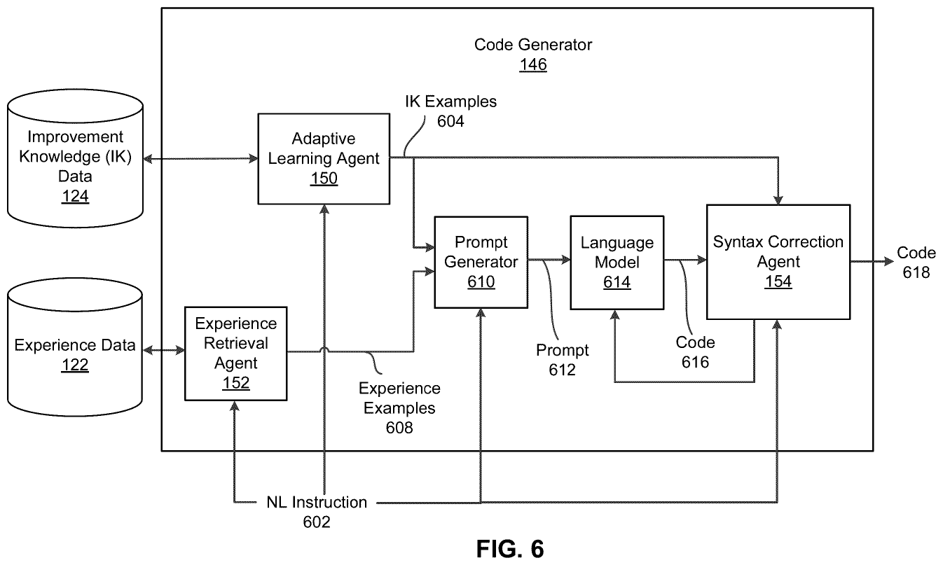

As shown, a code generator 146 that includes, without limitation, an adaptive learning agent 150, an experience retrieval agent 152, and a syntax correction agent 154, is stored in a system memory 144, and executes on processor(s) 142, of the computing device 140. In some embodiments, the system memory 144 and the processor(s) 142 can be similar to the system memory 114 and the processor(s) 112 of the server 110, described above. The code generator 146 is described in greater detail below in conjunction with FIGS. 6-11 and 13-15. Although shown as being distinct from the training application 116 for illustrative purposes, in some embodiments, functionality of the training application 116 and the code generator 146 can be combined into a single application executing on a single computing device or separated into any technically feasible number of different applications executing on any number of computing devices.

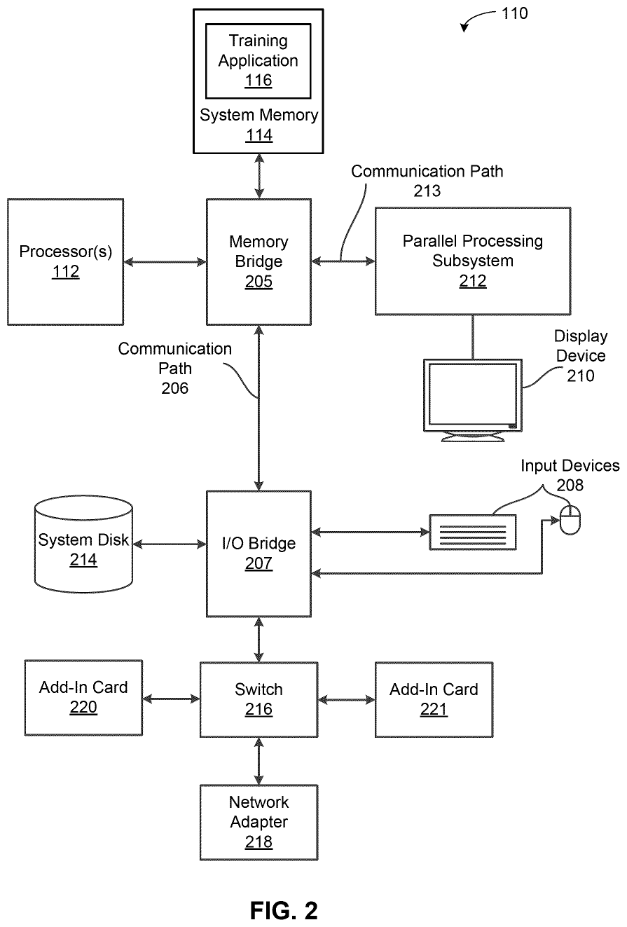

FIG. 2 is a more detailed illustration of the server 110 of FIG. 1, according to various embodiments. The server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the server 110 is a server machine operating in a data center or a cloud computing environment that provides scalable computing resources as a service over a network.

In various embodiments, the server 110 includes, without limitation, the processor(s) 112 and the system memory 114 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the server 110 may be a server machine in a cloud computing environment. In such embodiments, the server 110 may not include input devices 208, but may receive equivalent input information by receiving commands (e.g., responsive to one or more inputs from a remote computing device) in the form of messages transmitted over a network and received via the network adapter 218. In some embodiments, the switch 216 is configured to provide connections between the I/O bridge 207 and other components of the server 110, such as a network adapter 218 and various add-in cards 220 and 221.

In some embodiments, the I/O bridge 207 is coupled to a system disk 214 that may be configured to store content and applications and data for use by processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, the communication paths 206 and 213, as well as other communication paths within the server 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the training application 116. Although described herein primarily with respect to the training application 116, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system. For example, the parallel processing subsystem 212 may be integrated with the processor(s) 112 and other connection circuitry on a single chip to form a system on a chip (SoC).

In some embodiments, the processor(s) 112 includes the primary processor of server 110, controlling and coordinating operations of other system components. In some embodiments, the processor(s) 112 issue commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, the system memory 114 could be connected to the processor(s) 112 directly rather than through the memory bridge 205, and other devices may communicate with the system memory 114 via the memory bridge 205 and the processor(s) 112. In other embodiments, the parallel processing subsystem 212 may be connected to the I/O bridge 207 or directly to the processor(s) 112, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. For example, the parallel processing subsystem 212 may be implemented as a virtualized parallel processing subsystem in at least one embodiment. As a specific example, the parallel processing subsystem 212 may be implemented as virtual graphics processing unit(s) (vGPU(s)) that render graphics on a virtual machine(s) (VM(s)) executing on server machine(s) whose GPU(s) and other physical resources are shared across one or more VMs.

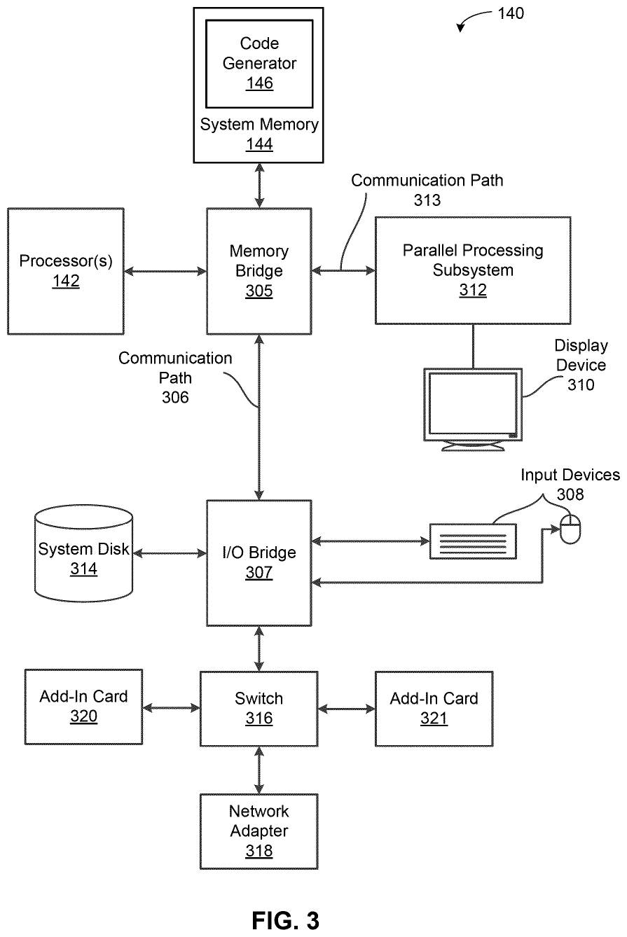

FIG. 3 is a more detailed illustration of the computing device 140 of FIG. 1, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network.

In various embodiments, the computing device 140 includes, without limitation, the processor(s) 142 and the system memory 144 coupled to a parallel processing subsystem 312 via a memory bridge 305 and a communication path 313. The memory bridge 305 is further coupled to an I/O bridge 307 via a communication path 306, and the I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, the computing device 140 may not include the input devices 308, but may receive equivalent input information by receiving commands (e.g., responsive to one or more inputs from a remote computing device) in the form of messages transmitted over a network and received via the network adapter 318. In some embodiments, the switch 316 is configured to provide connections between the I/O bridge 307 and other components of the computing device 140, such as a network adapter 318 and various add-in cards 320 and 321.

In some embodiments, the I/O bridge 307 is coupled to a system disk 314 that may be configured to store content and applications and data for use by the processor(s) 142 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 307 as well.

In various embodiments, the memory bridge 305 may be a Northbridge chip, and the I/O bridge 307 may be a Southbridge chip. In addition, the communication paths 306 and 313, as well as other communication paths within the computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more PPUs, also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 144 includes at least one device driver configured to manage the processing operations of the one or more PPUs within the parallel processing subsystem 312. In addition, the system memory 144 includes the code generator 146. Although described herein primarily with respect to the code generator 146, techniques disclosed herein can also be implemented, either entirely or in part, in other software and/or hardware, such as in the parallel processing subsystem 312.

In various embodiments, the parallel processing subsystem 312 may be integrated with one or more of the other elements of FIG. 3 to form a single system. For example, the parallel processing subsystem 312 may be integrated with the processor(s) 142 and other connection circuitry on a single chip to form a SoC.

In some embodiments, the processor(s) 142 includes the primary processor of the computing device 140, controlling and coordinating operations of other system components. In some embodiments, the processor(s) 142 issue commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 312, may be modified as desired. For example, in some embodiments, the system memory 144 could be connected to the processor(s) 142 directly rather than through the memory bridge 305, and other devices may communicate with the system memory 144 via the memory bridge 305 and the processor(s) 142. In other embodiments, the parallel processing subsystem 312 may be connected to the I/O bridge 307 or directly to the processor(s) 142, rather than to the memory bridge 305. In still other embodiments, the I/O bridge 307 and the memory bridge 305 may be integrated into a single chip instead of existing as one or more discrete devices. In certain embodiments, one or more components shown in FIG. 3 may not be present. For example, the switch 316 could be eliminated, and the network adapter 318 and the add-in cards 320, 321 would connect directly to the I/O bridge 307. Lastly, in certain embodiments, one or more components shown in FIG. 3 may be implemented as virtualized resources in a virtual computing environment, such as a cloud computing environment. For example, the parallel processing subsystem 312 may be implemented as a virtualized parallel processing subsystem in at least one embodiment. As a specific example, the parallel processing subsystem 312 may be implemented as virtual graphics processing unit(s) (vGPU(s)) that render graphics on a virtual machine(s) (VM(s)) executing on server machine(s) whose GPU(s) and other physical resources are shared across one or more VMs.

### Generating Code from Natural Language Instructions Using a Multi-Agent Framework

FIG. 4 is a more detailed illustration of the training application 116 of FIG. 1, according to various embodiments. As shown, the training application 116 includes, without limitation, the adaptive learning agent 150. During training, the adaptive learning agent 150 iteratively generates code based on an example natural language instruction, checks the generated code against reference code for functional and/or syntax errors, and generates improvement knowledge that includes rules for improving at generating code for the example. Accordingly, the adaptive learning agent 150 implements a feedback-driven improvement technique for learning improvement knowledge from examples, and the learned improvement knowledge can be applied to future unseen examples of translating natural language instructions into program code

In operation, the training application 116 retrieves, from a training data set 401, example pairs of natural language instructions (also referred to herein as “natural language specifications”) and reference code, shown as a pair of natural language (NL) instruction 402 and corresponding reference code (RC) 403, a pair of natural language instruction 412 and corresponding reference code 413, and a pair of natural language instruction 422 and corresponding reference code 423. In each pair of natural language instruction and reference code, the natural language instruction includes text describing code to be generated in natural language, and the corresponding reference code includes an example of program code to be generated for the natural language instruction. In some embodiments, the experience retrieval agent 152 can also store pairs of natural language instructions and reference code in the experience data 122 for use in generating program code.

The training application 116 processes each retrieved pair of natural language instruction and reference code in an iterative manner to generate improvement knowledge. Illustratively, for the natural language instruction 402 and the corresponding reference code 403, during a first iteration of training, the adaptive learning agent 150 included in the training application 116 prompts a language model (not shown) using a prompt that includes the natural language instruction 402 to generate code 404. Any technically feasible trained language model, such as a trained large language model (LLM), can be used in some embodiments. Further, the language model can be included in the adaptive learning agent 150, or the language model can execute elsewhere. For example, in some embodiments, the language model can execute in a cloud computing environment and be accessed via an application programming interface (API). In some embodiments, a single language model can be used by the training application 116 and the code generator 146 to perform different tasks. In some other embodiments, different language models, such as fine-tuned language models, can be used by the training application 116 and the code generator 146 to perform different tasks. After the code 404 is generated, the adaptive learning agent 150 checks the generated code 404 for functional and/or syntax errors.

Functional errors can include differences in the functional behaviors implemented by the generated code 404 and by the reference code 403. In some embodiments, adaptive learning agent 150 can use any technically feasible tool to evaluate whether the generated code 404 maintains the functionality of the reference code 403, i.e., whether the generated code 404 is logically equivalent to the reference code 403. For example, in some embodiments, Property Equivalence Checking (PEC) can be used to determine if the generated code 404 and the reference code 403 are functionally identical, verifying that the correction process preserves the intended behavior specified in the original reference code 403. In some embodiments, in addition to or in lieu of checking for functional errors, adaptive learning agent 150 can check whether the generated code 404 is textually similar to the reference code 403 using, for example, BLEU (Bilingual Evaluation Understudy). BLEU is a metric that measures similarity between texts by comparing n-grams of the two texts, providing a score between 0 and 1. Higher BLEU scores indicate closer similarity, suggesting better preservation of intended meaning, and vice versa.

Syntax errors can include errors that prevent the code 404 from compiling successfully, which can be identified using a code verification tool. In some embodiments, syntax errors can be identified using a syntax checking tool to verify the structural correctness of program code against syntax rules, ensuring that the program code is valid and can be correctly interpreted by verification tools.

Illustratively, when functional and/or syntax error(s) are identified in the code 404 and less than a maximum number of training iterations have been performed, the adaptive learning agent 150 prompts the language model to reflect on the error(s) and generate improvement knowledge 405. The improvement knowledge 405 includes one or more rules, in text format, to enhance the accuracy of code generation for the example natural language instruction 402. For example, in some embodiments, the rule(s) can include a list of suggestions, each of which is a sentence.

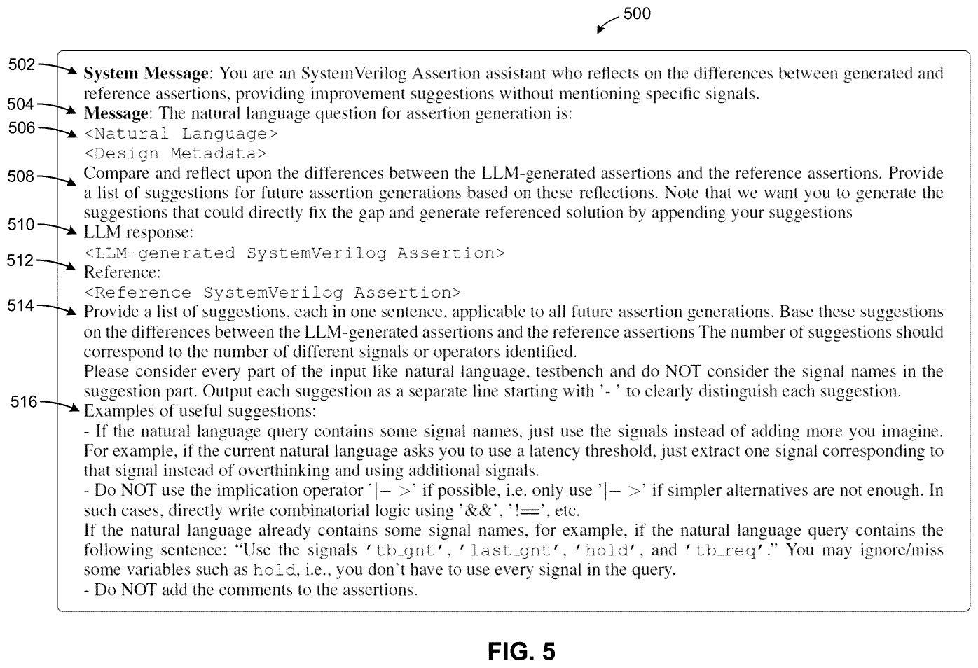

FIG. 5 illustrates an exemplar prompt for self-reflection and generating improvement knowledge, according to various embodiments. As shown, a prompt 500 includes, without limitation, a system message 502 and a message 504. The system message 502 describes a role of a language model as “an SystemVerilog Assertion assistant who reflects on the differences between generated and reference assertions, providing improvement suggestions without mentioning specific signals.” Although described herein primarily with respect to System Verilog Assertions (SVAs) as a reference example, in some embodiments, any suitable text, such as other types of program code, can be generated and reflected upon in order to generate improvement knowledge, which can in turn be used to generate additional text from natural language instructions.

The message 504 includes natural language instruction 506 that was input into a language model, code 510 generated by the language model, reference code 512, instructions 508 to compare and reflect upon differences between the generated code 510 and the reference code 512, instructions 514 to generate improvement knowledge and guidelines on the format of the improvement knowledge, and examples 516 of useful suggestions. Given the prompt 500, the language model can generate improvement knowledge, such as one of the improvement knowledge 405, 407, or 415 described above in conjunction with FIG. 4.

Returning to FIG. 4, during a second iteration, the adaptive learning agent 150 prompts the language model using a prompt that includes the natural language instruction 402 and the improvement knowledge 405 to generate updated code, shown as code 406. In some embodiments, during each subsequent iteration, the prompt that is input into the language model can also include the textual similarity score (e.g., a BLEU score) and/or functional equivalence score, described above, which can indicate to the language model whether progress is being made towards generating correct code. Then, the adaptive learning agent 150 checks whether there are functional and/or syntax error(s) in the code 406, which is similar to the description above with respect to checking the code 404. Illustratively, when functional and/or syntax error(s) are identified in the code 406 and less than the maximum number of training iterations have been performed, the adaptive learning agent 150 prompts the language model to reflect on the error(s) and generate improvement knowledge 407 that includes one or more rules for more accurately generating code for the example natural language instruction 402.

During a third iteration, the adaptive learning agent 150 prompts the language model using a prompt that includes the natural language instruction 402 and the improvement knowledge 407 to generate updated code, shown as code 408. Then, the adaptive learning agent 150 checks whether there are functional and/or syntax error(s) in the code 408, which is similar to the description above with respect to checking the code 404. Illustratively, the code 408 does not include functional and/or syntax error(s). When no functional and/or syntax errors are identified, or after a maximum number of iterations have been performed, adaptive learning agent 150 saves the latest improvement knowledge, which is the improvement knowledge 407 in this example, in the improvement knowledge data 124. The improvement knowledge 407 is stored along with the natural language instruction 402 in the improvement knowledge data 124. Thereafter, the improvement knowledge 407 can be extracted and used as an example in future prompts to the language model to generate code, as described below in conjunction with FIGS. 6-11 and 13-15.

For the natural language instruction 412 and the corresponding reference code 413, during a first iteration of training, the adaptive learning agent 150 prompts the language model using a prompt that includes the natural language instruction 412 to generate code 414. Then, the adaptive learning agent 150 checks whether there are functional and/or syntax error(s) in the code 414, which is similar to the description above with respect to checking the code 404. Illustratively, when functional and/or syntax error(s) are identified in the code 414 and less than the maximum number of training iterations have been performed, the adaptive learning agent 150 prompts the language model to reflect on the error(s) and generate improvement knowledge 415 that includes one or more rules for more accurately generating code for the example natural language instruction 412.

During a second iteration, the adaptive learning agent 150 prompts the language model using a prompt that includes the natural language instruction 412 and the improvement knowledge 415 to generate updated code, shown as code 416. Then, the adaptive learning agent 150 checks whether there are functional and/or syntax error(s) in the code 416, which is similar to the description above with respect to checking the code 404. Illustratively, the code 416 does not include functional and/or syntax error(s). When no functional and/or syntax errors are identified, or after a maximum number of iterations have been performed, then the adaptive learning agent 150 saves the latest improvement knowledge, which is the improvement knowledge 415 in this example, in the improvement knowledge data 124. The improvement knowledge 415 is stored along with the natural language instructions 412 in the improvement knowledge data 124.

For the natural language instruction 422 and the corresponding reference code 423, during a first iteration of training, the adaptive learning agent 150 prompts the language model using a prompt that includes the natural language instruction 422 to generate code 424. Then, the adaptive learning agent 150 checks whether there are functional and/or syntax error(s) in the code 424, which is similar to the description above with respect to checking the code 404. Illustratively, no functional and/or syntax errors are identified in the code 424, and no improvement knowledge is generated.

More specifically, the problem of translating natural language instructions to program code can be defined as follows in the case of SVA. Let

$$𝒟 = {\{ ( {x}_{i} , {y}_{i} ) \}}_{i = 1}^{N}$$

represent the dataset, where xᵢ is a natural language (NL) specification, and yᵢ is the corresponding reference SVA. The dataset can be divided into: (1) a training set:

$${𝒟}_{train} = {\{ ( {x}_{i} , {y}_{i} ) \}}_{i = 1}^{{N}_{train}} ,$$

and (2) a testing set:

$${𝒟}_{test} = {\{ ( {x}_{i} , {y}_{i} ) \}}_{i = 1}^{{N}_{test}} ,$$

where Nₜᵣₐᵢₙ and Nₜₑₛₜ are the sizes of the training and testing sets, respectively. The desired agent can be defined as a function f_{θ}:X→ [symbol] , parameterized by θ, mapping natural language specifications x∈X to SVAs ŷ=f_{θ}(x)∈ [symbol] . The goal is to optimize f_{θ} so that the generated SVA ŷ closely matches the reference y for unseen specifications x in the test set, evaluated by metrics for syntax correctness, functionality, and linguistic similarity. Instead of directly optimizing parameters of a language model or prompt, the adaptive learning agent 150 learns improvement knowledge that includes text-based strategies to enhance the generation process. Further, the adaptive learning agent 150 verifies the effectiveness of improvement knowledge through practical trials, incorporating only proven beneficial knowledge into the improvement knowledge data 124.

During training, the training application 116 utilizes the training set [symbol] ₜᵣₐᵢₙ to build two key resources: (1) experience data ε 122: the experience retrieval agent 152 stores the NL-SVA pairs (xᵢ, yᵢ) ∈ [symbol] ₜᵣₐᵢₙ for future retrieval; (2) improvement knowledge data [symbol] 124: The adaptive learning agent 150 can generate and refine a text-based knowledge base

$$𝒥 = {\{ {φ}_{m} \}}_{m = 1}^{M} ,$$

where each φₘ represents a rule, suggestion, principle, or lesson learned during the training process, allowing generalization to handle unseen examples after training. More specifically, the adaptive learning agent 150 can use a feedback driven improvement mechanism, enabling a language model to iteratively refine SVA generation capabilities by learning from past mistakes. During training, the adaptive learning agent 150 processes the training set [symbol] ₜᵣₐᵢₙ to generate and refine improvement knowledge data 1

$$𝒥 = {\{ {φ}_{m} \}}_{m = 1}^{M}$$

24. The training process mimics traditional machine learning training while providing: (1) adaptive text-based improvement knowledge data as “Model Weights” updates; (2) equivalence checking as flexible “Loss Functions”; (3) a parallelizable architecture enabling efficient “Mini-batch” processing. During the iterative learning, for each example (xᵢ, yᵢ) ∈ [symbol] ₜᵣₐᵢₙ, the adaptive learning agent performs a “forward pass” to generate a candidate SVA ŷᵢ=f_{θ}(xᵢ), denoted as “LLM.GenInitSVA (xᵢ)” in Algorithm 1 below. Then, the generated SVA ŷᵢ is compared to the reference ŷᵢ using: (1) a quick textual similarity assessment, such as a BLEU score, and/or (2) a more advanced functional equivalence checking tool for thorough semantic comparison. While a textual similarity assessment offers speed, the textual similarity assessment can sometimes miss semantic equivalences in syntactically different but functionally identical SVAs (e.g., reordered clauses). The functional equivalence checking tool, though more computationally intensive, can identify such functional equivalences, presenting a trade-off between speed and accuracy in the comparison process. If ŷᵢ is deemed not equivalent to ŷᵢ based on the chosen comparison method, the agent initiates an iterative correction loop as shown in lines 5-9 of Algorithm 1 below. The language model analyzes the mismatch, proposes new improvement knowledge data φ, which are then validated by incorporating the new improvement knowledge data into the prompt and re-running the forward pass to generate an updated ŷᵢ. Such a correction process continues until ŷᵢ matches yᵢ or a maximum iteration count is reached. Validated improvement knowledge that successfully corrects ŷᵢ to ŷᵢ is stored in the improvement knowledge data 124. Further, to enhance efficiency, training data can be grouped into mini-batches and processed concurrently across multiple instances in some embodiments, significantly speeding up the training process.

In some embodiments, the training application 116 can perform training according to the pseudocode of Algorithm 1:

Algorithm 1: Adaptive Learning Agent Training

```
Input: Training dataset [symbol]   ₜᵣₐᵢₙ, Max iterations Iₘₐₓ
Output: [symbol]
Initialize [symbol]   ← Ø
for each (xᵢ, yᵢ) ∈ [symbol]   ₜᵣₐᵢₙ do
  ŷᵢ ← LLM.GenInitSVA (xᵢ) {Forward pass}
  Initialize iteration count: n ← 0
  while ŷᵢ does not match yᵢ and n < Iₘₐₓ do
    φᵢ ← LLM.AnalyzeErrors (ŷᵢ, yᵢ) {Generate IK}
    ŷᵢ ← LLM.GenSVA (xᵢ, φᵢ) {Refinement with IK}
    n ← n + 1
  end while
  if ŷᵢ matches yᵢ then [symbol]
    ← [symbol]   ∪ φᵢ
  end if
end for
return [symbol]
```

In some embodiments, the adaptive learning agent 150 operates without gradient updates or fine-tuning, instead building text-based improvement knowledge data 124 through offline training on [symbol] ₜᵣₐᵢₙ, which can be regarded as curated examples. Such an approach yields transferable knowledge, [symbol] , applicable to unseen examples, enabling continuous improvement as more data becomes available.

FIG. 6 is a more detailed illustration of the code generator 146 of FIG. 1, according to various embodiments. As shown, the code generator 146 includes, without limitation, the adaptive learning agent 150, the experience retrieval agent 152, a prompt generator 610, a language model 614, and the syntax correction agent 154. In operation, given as input natural language instruction 602 for code to generate, the experience retrieval agent 152 retrieves relevant experience examples 608 from the experience data 122; the adaptive learning agent 150 extracts relevant improvement knowledge examples 604 from improvement knowledge that is retrieved from the improvement knowledge data 124; the prompt generator generates a prompt 612 that includes the natural language instruction 602, the experience examples 608, and the improvement knowledge examples 604; the code generator 146 prompts the language model 614 using the prompt 612 to generate code 616; and the syntax correction agent verifies the generated code 616 and, if necessary, corrects the code 616 to generate updated code 618.

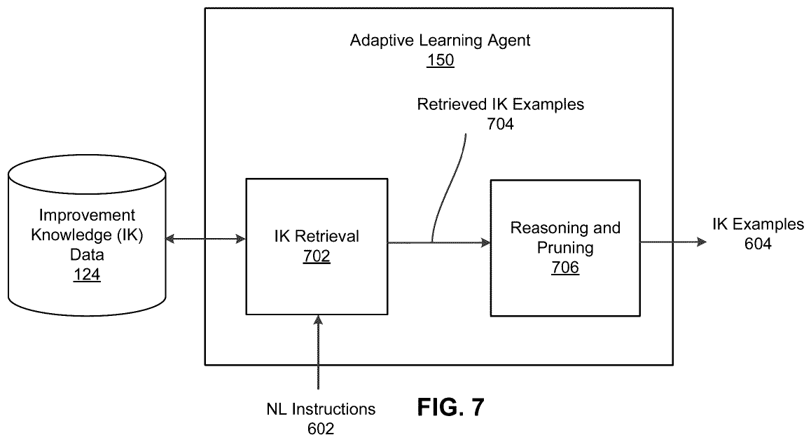

The adaptive learning agent 150 performs an embedding search to retrieve improvement knowledge that is relevant to the natural language instruction 602, and the adaptive learning agent 150 reasons about and prunes the retrieved improvement knowledge to extract improvement knowledge examples 604. FIG. 7 illustrates how the adaptive learning agent 150 of FIG. 6 extracts the improvement knowledge examples 604, according to various embodiments. As shown, the adaptive learning agent 150 includes, without limitation, an improvement knowledge retrieval module 702 and a reasoning and pruning module 706. The improvement knowledge retrieval module 702 performs an embedding search to retrieve improvement knowledge that is relevant to the natural language instruction 602. As described, the improvement knowledge data 124 stores improvement knowledge along with the natural language instructions for which the improvement knowledge was generated. The improvement knowledge retrieval module 702 generates and compares an embedding of the natural language instruction 602 against embeddings of natural language instructions in the improvement knowledge data 124 to identify one or more most similar natural language instructions in the improvement knowledge data 124. Then, the improvement knowledge retrieval module 702 retrieves improvement knowledge associated with the most similar natural language instruction(s) in the improvement knowledge data 124.

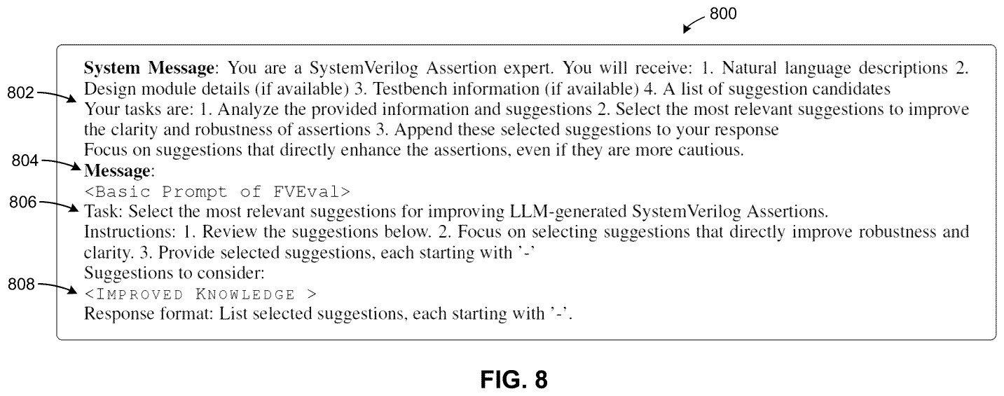

The reasoning and pruning module 706 reasons about the retrieved improvement knowledge examples 704 and prunes the retrieved improvement knowledge examples 704 to extract the improvement knowledge examples 604 that include the most relevant improvement knowledge for generating code according to the natural language instruction 602. In some embodiments, the reasoning and pruning module 706 prompts a language model to reason about and prune the retrieved improvement knowledge examples 704 to select the most relevant improvement knowledge examples 604 given the input natural language instruction 602. FIG. 8 illustrates an exemplar prompt for reasoning and pruning when generating improvement knowledge examples, according to various embodiments. As shown, a prompt 800 includes, without limitation, a system message 802 and a message 804. The system message 802 describes a role of a language model as “an SystemVerilog Assertion expert” with the tasks of “1. Analyze the provided information and suggestions, 2. Select the most relevant suggestions to improve the clarity and robustness of assertions, and 3. Append these selected suggestions to your response. Focus on suggestions that directly enhance the assertions, even if they are more cautious.”

The message 804 includes a task 806, to be performed by the language model, of reasoning about improvement knowledge 808 that has been retrieved from the improvement knowledge data 124 and pruning the improvement knowledge 806 to extract the improvement knowledge examples 604 that can be used in generating code. Illustratively, the task 806 asks the language model to “Select the most relevant suggestions for improving LLM-generated SystemVerilog Assertions. Instructions: 1. Review the suggestions below. 2. Focus on selecting suggestions that directly improve robustness and clarity. 3. Provide selected suggestions, each starting with ‘-’.”

Returning to FIG. 6, the experience retrieval agent 152 performs an embedding search to retrieve, from the experience data 122, experience examples 608 that are relevant to the natural language instruction 602. In some embodiments, the experience examples 608 can include previous examples of translating natural language instructions to program code. In such cases, the experience retrieval agent 152 can generate an embedding of the natural language instruction 602 and compare the embedding to embeddings of natural language instructions in the experience data 122 to identify one or more most similar natural language instructions in the experience data 122. Then, the experience retrieval agent 152 can retrieve, from the experience data 122, one or more experience examples associated with (e.g., that include) the one or more most similar natural language instructions. The retrieved experience can provide relevant context, which offer hints, for a language model to generate more accurate program code.

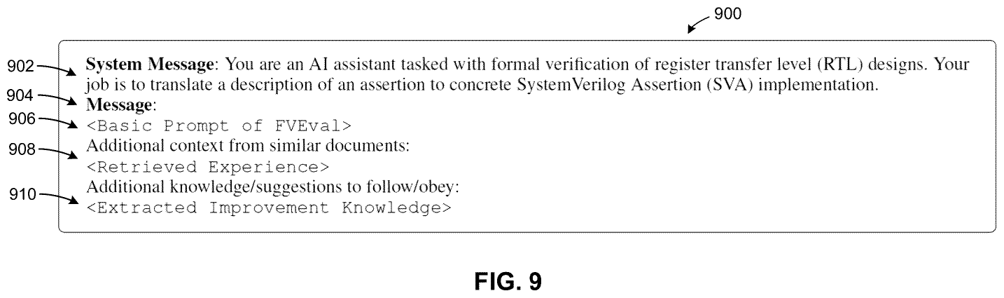

The prompt generator 610 is a module that takes the natural language instruction 602, the experience examples 608, and the improvement knowledge examples 604 as input. Given such inputs, the prompt generator 610 generates a prompt 612 for prompting the language model 614 to generate code 616 according to the natural language instruction 602 and using the experience examples 608 and the improvement knowledge examples 604. FIG. 9 illustrates an exemplar prompt for generating code that the prompt generator 610 can generate, according to various embodiments. As shown, a prompt 900 includes, without limitation, a system message 902 and a message 904. The system message 902 describes a role of a language model as “an AI assistant tasked with formal verification of register transfer level (RTL) designs. Your job is to translate a description of an assertion to concrete SystemVerilog Assertion (SVA) implementation.” The message 904 includes a basic prompt 906 that includes a natural language instruction on code to generate, retrieved experience examples 908 that are relevant to the natural language instructions, and extracted improvement knowledge 910 that are relevant to the natural language instructions.

Returning to FIG. 6, the syntax correction agent 154 processes the code 616 generated by the language model 614 to verify the syntax of the code 616. Verifying the syntax can include verifying that the code 616 is able to be compiled and executed. In some embodiments, syntax errors can be identified using a syntax checking tool to verify the structural correctness of program code against syntax rules, ensuring that the program code is valid and can be correctly interpreted by verification tools. When the syntax correction agent 154 fails to verify the code 616, then the syntax correction agent 154 iteratively prompts a language model, shown as the language model 614, to re-generate the code, until code is generated that is successfully verified. In some embodiments, the prompt at each iteration indicates error(s) identified at a previous iteration and asks the language model to analyze the error(s) and re-generate program code to fix the error(s), and the prompt includes the improvement knowledge examples 604 to assist the language model in re-regenerating program code. Once verification is successful, the verified code can then be output as the code 618.

Although generation of improvement knowledge is described herein primarily as occurring during training by the training application 116, in some embodiments, the adaptive learning agent 150 in the code generator 146 can also generate improvement knowledge from errors made by the language model during testing (deployment). In some embodiments, the improvement knowledge can be generated through self reflection by the language model, similar to the description above in conjunction with FIGS. 4-5. Accordingly, the improvement knowledge data 124 can continuously grow in some embodiments.

More specifically, returning to the SVA case and assuming that training has been completed, for a given NL specification x∈ [symbol] ₜₑₛₜ: (1) the experience retrieval agent 152 retrieves NL-SVA pairs

$${\{ ( {x}_{r}^{j} , {y}_{r}^{j} ) \}}_{j = 1}^{K} ⊆ ε$$

that include a NL specification similar to the given NL specification from the experience data 122. Then, (2) the adaptive learning agent 150 selects relevant improvement knowledge

$${\{ {φ}_{s}^{l} \}}_{l = 1}^{L} ⊆ 𝒥$$

based on the current context via a two-staged process. Such augmentations (retrieved examples and improvement knowledge) enhance the original NL query for SVA generation:

$$\hat{y} = {f}_{θ} ( x , {\{ {x}_{r}^{j} , {y}_{r}^{j} \}}_{j = 1}^{K} , {\{ {φ}_{s}^{l} \}}_{l = 1}^{L} ) .$$

After the SVA is generated, (3) the generated SVA ŷ undergoes iterative validation and refinement by the syntax correction agent 154 to ensure syntactic correctness.

The experience retrieval agent 152 operates on the experience data ε constructed during the training phase. Given a new NL specification x∈ [symbol] ₜₑₛₜ during testing, the experience retrieval agent 152 aims to retrieve contextually relevant NLSVA pairs from E to aid in generating a high-quality SVA for x. Given the set of stored NL specifications {x₁, x₂, . . . , xₙ} ∈ε, the experience retrieval agent 152 can compute a cosine similarity score sᵢ for each xᵢ. Such a similarity function, or any other technically feasible metric of distance, can be used to capture semantic relationships. The experience retrieval agent 152 then selects the top-K most relevant NL-SVA pairs

$${\{ ( {x}_{r}^{j} , {y}_{r}^{j} ) \}}_{j = 1}^{K}$$

from ε based on these similarity scores. The retrieved pairs provide valuable context to the language model (e.g., an LLM), guiding the language model towards generating an SVA that aligns with proven patterns and best practices observed in the training data.

The adaptive learning agent 150 utilizes the improvement knowledge [symbol] collected during training to enhance the generation of SVAs for new NL specifications in a test (deployment) data set x∈ [symbol] ₜₑₛₜ. The testing phase can include two stages: (1) an improvement knowledge candidate selection stage, and (2) an improvement knowledge refinement stage using a language model. During the improvement knowledge candidate selection stage, the adaptive learning agent 150 retrieves a candidate set of IK data

$${\{ {φ}_{s}^{l} \}}_{l = 1}^{L} ⊆ 𝒥$$

using a top-K selection process based on similarity metrics that compare the new specification x with those seen during training. During the improvement knowledge refinement stage, the adaptive learning agent 150 prompts the language model to reason about the selected improvement knowledge candidates, refining such improvement knowledge candidates to identify the most useful strategies. Such a two-staged process helps to ensure that only the most relevant and effective improvement knowledge data is utilized, enhancing the accuracy and robustness of the generated SVAs during the testing stage.

The refined set of improvement knowledge examples is used to augment the prompt for generating the SVA

$$\hat{y} = {f}_{θ} ( x , {\{ {x}_{r}^{j} , {y}_{r}^{j} \}}_{j = 1}^{K} , {\{ {φ}_{s}^{l} \}}_{l = 1}^{L} ) .$$

Then, the generated SVA ŷ undergoes validation and iterative refinement by the syntax correction agent 154 to ensure syntactic correctness. In some embodiments, the syntax correction agent 154 utilizes a SVA syntax checking tool, such as Jasper, to ensure the syntactic correctness of generated SVAs. The syntax correction agent 154 refines the output ŷ produced by the function f_{θ}. For a given NL specification x∈ [symbol] ₜₑₛₜ and the initially generated SVA

$$\hat{y} = {f}_{θ} ( x , {\{ {x}_{r}^{j} , {y}_{r}^{j} \}}_{j = 1}^{K} , {\{ {φ}_{s}^{l} \}}_{l = 1}^{L} ) ,$$

the syntax correction agent 154 can perform the following iterative process shown below in the pseudocode of Algorithm 2. If the SVA syntax checking tool identifies any syntax errors in the generated ŷ, the language model analyzes the feedback from the SVA syntax checking tool report, which can indicate the locations and types of errors. The language model then proposes corrections based on the analysis and generates an updated ŷ. The foregoing process of checking, analyzing, and correcting can continue iteratively until the SVA syntax checking tool confirms that there are no syntax errors or until a predefined maximum number of iterations is reached.

Algorithm 2: Syntax Correction Agent

```
Input: NL specification x, initial SVA ŷ, maximum attempts maxAttempt
Output: Corrected SVA ŷ, syntactic correctness indicator isCorrect
attempts ← 0
while attempts < maxAttempts do
  result, syntax_{info} ← JASPER.Check (ŷ)
  if result = PASS then
    return ŷ, TRUE
  else
    ŷ ← LLM.GenSVA (x, ŷ, syntax_info)
    attempts ← attempts + 1
  end if
end while
return ŷ, FALSE
```

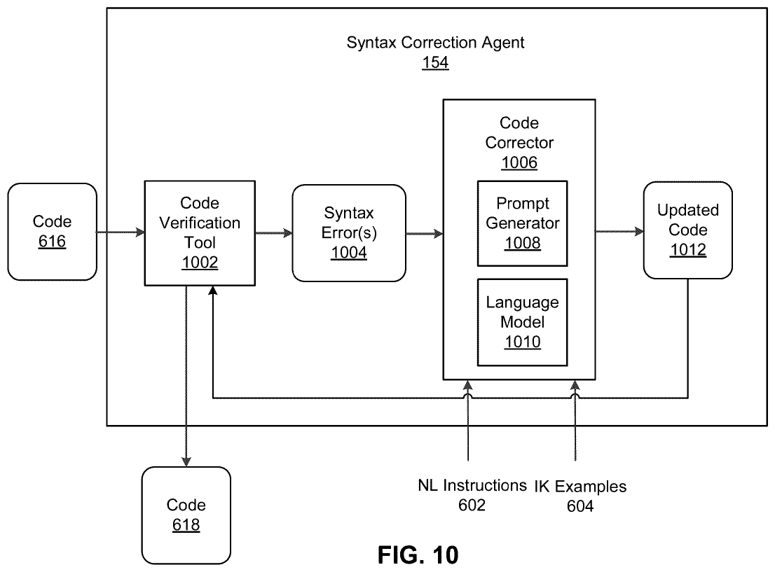

FIG. 10 illustrates how the syntax correction agent of FIG. 6 corrects generated code, according to various embodiments. As shown, the syntax correction agent 154 includes, without limitation, a code verification tool 1002 and a code corrector module 1006. The code corrector module 1006 includes, without limitation, a prompt generator 1008 and a language model 1010. In some embodiments, the language model 1010 can be the same as or different from the other language models described herein, such as the language model 614. Although shown as being included in the code corrector module 1006 for illustrative purposes, in some embodiments, the language model 1010 can execute elsewhere. For example, in some embodiments, the language model 1010 can execute in a cloud computing environment and be accessed via an API.

The code verification tool 1002 is configured to check code for syntax errors. In some embodiments, the code verification tool 1002 can verify that input code is able to be compiled and executed. Any technically feasible code verification tool 1002 can be used in some embodiments, including known code verification tools. Illustratively, given as input the code 616, the code verification tool 1002 can output one or more syntax errors 1004. Alternatively, if the code verification tool 1002 determines that the code 616 does not include any syntax errors, then the syntax correction agent 154 can output the same code 616 as the code 618.

The code corrector module 1006 processes the syntax error(s) 1004, the natural language instruction 602, and the improvement knowledge examples 604 that are relevant to the natural language instruction 602 to generate updated code 1012. In some embodiments, the prompt generator 1008 in the code corrector module 1006 generates a prompt that includes the natural language instruction 602, the code 616, and the syntax error(s) 1004, and the prompt asks the language model 1010 to correct the syntax error(s) 1004 in the code 616. Given such a prompt as input, the language model 1010 generates updated code 1012. Then, the syntax correction agent 154 verifies the updated code 1012 using the code verification tool 1002. Similar to the description above with respect to the code 616, the code verification tool 1002 can identify syntax error(s) in the updated code 1012, which the code corrector module 1006 can attempt to correct. Alternatively, if the code verification tool 1002 determines that the updated code 1012 does not include any syntax errors, then the syntax correction agent 154 can output the updated code 1012 as the code 618.

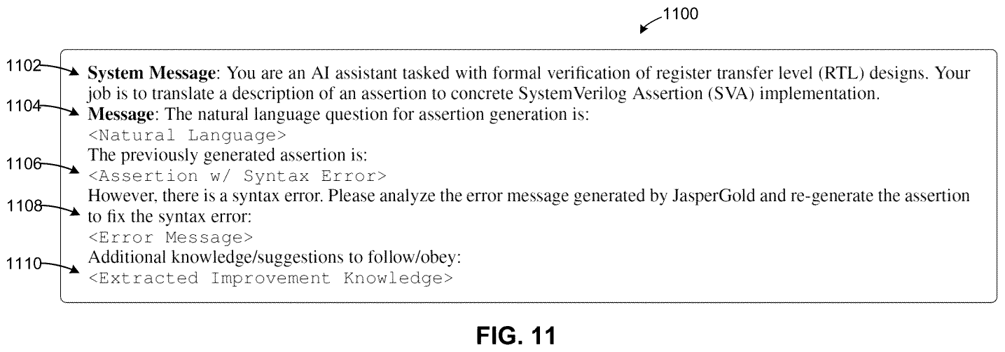

FIG. 11 illustrates an exemplar prompt for correcting generated code, according to various embodiments. As shown, a prompt 1100 includes, without limitation, a system message 1102 and a message 1104. The system message 1102 describes a role of a language model as “an AI assistant tasked with formal verification of register transfer level (RTL) designs. Your job is to translate a description of an assertion to concrete SystemVerilog Assertion (SVA) implementation.” The message 1104 includes the natural language instruction of code to generate (e.g., natural language instruction 602) as well as previously generated code 1106, an error message 1108 indicating syntax error(s) identified by the code verification tool 1002, and the improvement knowledge examples 1110 (e.g., improvement knowledge examples 604) that are relevant to the natural language instruction. The message 1104 asks the language model to re-generate the code to fix the syntax error(s) specified in the error message 1108. Given the prompt 1100 as input, the language model 1010 can generate updated code (e.g., updated code 1012) that attempts to fix the syntax error(s) (e.g., syntax error(s) 1004) in previously generated code (e.g., code 616 or updated code that was previously generated by the code corrector module 1006) that are identified by the code verification tool 1002.

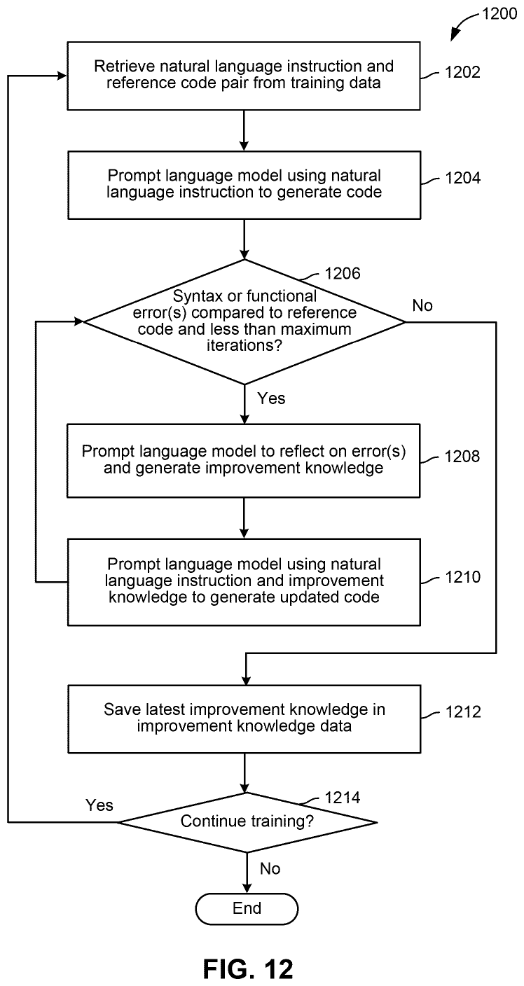

FIG. 12 is a flow diagram of method steps for performing training to generate improvement knowledge data, according to various embodiments. Although the method steps are described in conjunction with the systems of FIGS. 1-11, persons skilled in the art will understand that any system configured to perform the method steps in any order falls within the scope of the present embodiments.

As shown, a method 1200 begins at step 1202, where the adaptive learning agent 150 in the training application 116 retrieves a natural language instruction and reference code pair from training data (e.g., training data 401). As described, the adaptive learning agent 150 uses pairs of natural language instructions and reference code to generate improvement knowledge during training. In some embodiments, the experience retrieval agent 152 can also store pairs of natural language instructions and reference code in the experience data 122 for use in generating program code.

At step 1204, the adaptive learning agent 150 prompts a language model using the natural language instruction to generate code. In some embodiments, the prompt asks the language model to generate program code according to the natural language instruction.

At step 1206, if there are functional and/or syntax error(s) in the generated code compared to the reference code and less than a maximum number of iterations have been performed, then the method 1200 continues to step 1208, where the training application 116 prompts the language model to reflect on the error(s) and generate improvement knowledge. As described, the improvement knowledge can include one or more rules, in text format, to enhance the accuracy of code generation for the natural language instruction. For example, in some embodiments, the rule(s) can include a list of suggestions, each of which is a sentence. In some embodiments, the prompt to generate improvement knowledge can include the natural language instruction, the generated code, the reference code, instructions to compare and reflect upon differences between the generated code and the reference code, instructions to generate improvement knowledge and guidelines on the format of the improvement knowledge, and examples of useful suggestions, as described above in conjunction with FIG. 5. Given such a prompt, the language model can generate improvement knowledge.

At step 1210, the adaptive learning agent 150 prompts the language model using the natural language instruction and improvement knowledge to generate updated code. In some embodiments, during each iteration after a first iteration, the prompt that is input into the language model can include the textual similarity score (e.g., a BLEU score) and/or functional equivalence score that indicates to the language model whether progress is being made towards generating correct code. After step 1210, the method 1200 returns to step 1206, where the training application 116 again checks whether there are functional and/or syntax error(s) in the updated code compared to the reference code and less than a maximum number of iterations have been performed.

On the other hand, if the adaptive learning agent 150 determines at step 1206 that there are no functional and/or syntax error(s), or if a maximum number of iterations have been performed, then the method 1200 continues to step 1212, where the adaptive learning agent 150 saves the latest improvement knowledge in the improvement knowledge data 124. Thereafter, the saved improvement knowledge can be extracted and used as an example in future prompts to the language model to generate code.

At step 1214, if the adaptive learning agent 150 determines to continue training, then the method 1200 returns to step 1202, where the adaptive learning agent 150 retrieves another natural language instruction and reference code pair from the training data 401. Training can continue for any number of iterations, such as until all pairs of natural language instruction and reference code have been used. If the adaptive learning agent 150 determines to not continue training at step 1214, then the method 1200 ends.

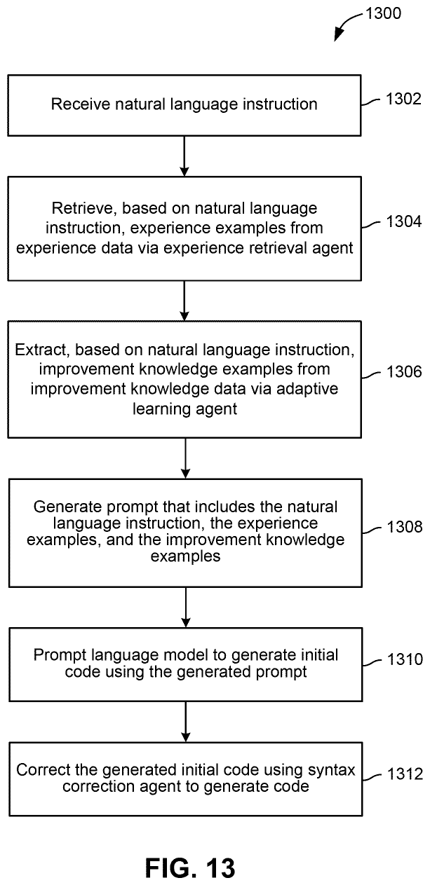

FIG. 13 is a flow diagram of method steps for generating code, according to various embodiments. Although the method steps are described in conjunction with the systems of FIGS. 1-11, persons skilled in the art will understand that any system configured to perform the method steps in any order falls within the scope of the present embodiments.

As shown, a method 1300 begins at step 1302, where the code generator 146 receives a natural language instruction. The natural language instructions can include text describing program code to generate in natural language. The natural language instruction can specify any technically feasible type of code, such as System Verilog assertions, to generate.

At step 1304, the code generator 146 retrieves, based on the natural language instructions, experience examples from the experience data 122 via the experience retrieval agent 152. In some embodiments, the experience retrieval agent 152 retrieves relevant experience examples from the experience data 122 using an embedding search, as described above in conjunction with FIGS. 6-7.

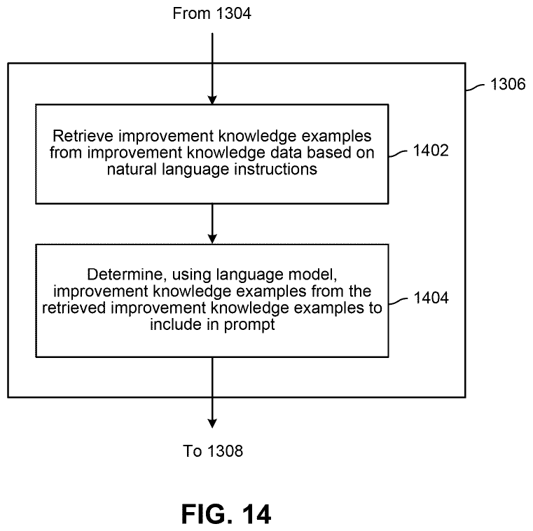

At step 1306, the code generator 146 extracts, based on the natural language instructions, improvement knowledge examples from the improvement knowledge data 124 via the adaptive learning agent 150. In some embodiments, the adaptive learning agent 150 performs a two-step process of (1) performing an embedding search to retrieve improvement knowledge that is relevant to the natural language instruction from the improvement knowledge data 124, and (2) prompting a language model to reason about and prune the retrieved improvement knowledge examples to extract one or more improvement knowledge examples that include the most relevant improvement knowledge for generating code according to the natural language instruction, as described above in greater detail below in conjunction with FIG. 14.

At step 1308, the code generator 146 generates a prompt that includes the natural language instruction, the experience examples, and the improvement knowledge examples. In some embodiments, the generated prompt can be in the format of the prompt 900 described above in conjunction with FIG. 9.

At step 1310, the code generator 146 prompts a language model to generate initial code using the generated prompt. In some embodiments, the code generator 146 inputs the generated prompt into the language model (e.g., language model 614), which outputs the initial code.

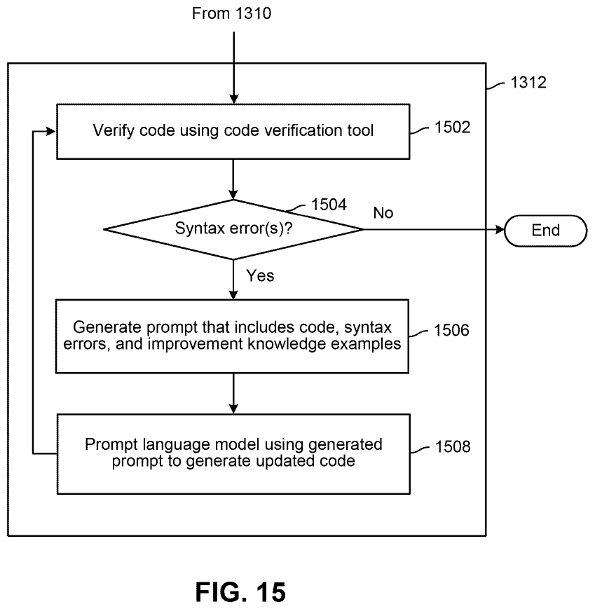

At step 1312, the code generator 146 corrects the initial code using the syntax correction agent 154 to generate code for output. In some embodiments, the syntax correction agent in the code generator 146 verifies the syntactic correctness of the initial code. In such cases, syntax errors can be identified using a syntax checking tool to verify the structural correctness of program code against syntax rules, ensuring that the program code is valid and can be correctly interpreted by verification tools. When the syntax correction agent 154 fails to verify the initial code, then the syntax correction agent 154 iteratively prompts the language model to re-generate the code, until code is generated that is successfully verified, as described in greater detail below in conjunction with FIG. 15. Once verification is successful, the verified code can then be output by the code generator 146.

FIG. 14 is a flow diagram of method steps for generating improvement examples at step 1306 of the method 1300, according to various embodiments. Although the method steps are described in conjunction with the systems of FIGS. 1-11, persons skilled in the art will understand that any system configured to perform the method steps in any order falls within the scope of the present embodiments.

As shown, at step 1402, the adaptive learning agent 150 retrieves improvement knowledge examples from the improvement knowledge data 124 based on the natural language instructions received at step 1302. As described, the improvement knowledge data 124 stores improvement knowledge along with the natural language instructions for which the improvement knowledge was generated. In some embodiments, the adaptive learning agent 150 generates and compares an embedding of the natural language instruction received at step 1302 against embeddings of natural language instructions in the improvement knowledge data 124 to identify one or more most similar natural language instructions in the improvement knowledge data 124. Then, the adaptive learning agent 150 retrieves improvement knowledge associated with the most similar natural language instruction(s) in the improvement knowledge data 124.

At step 1404, the adaptive learning agent 150 determines, using a language model, improvement knowledge examples from the retrieved improvement knowledge examples to include in a prompt. In some embodiments, the adaptive learning agent 150 prompts a language model to reason about and prune the improvement knowledge examples retrieved at step 1402 to select the most relevant improvement knowledge examples given the natural language instruction received at step 1302. In some embodiments, the prompt can have the format of the prompt 800 described above in conjunction with FIG. 8.

FIG. 15 is a flow diagram of method steps for correcting generated code at step 1312 of the method 1300, according to various embodiments. Although the method steps are described in conjunction with the systems of FIGS. 1-11, persons skilled in the art will understand that any system configured to perform the method steps in any order falls within the scope of the present embodiments.

As shown, at step 1502, the code generator 146 verifies code that has been generated using a code verification cool (e.g., code verification tool 1002). As described, in some embodiments, the code verification tool can be a syntax checking tool that verifies the structural correctness of program code against syntax rules, ensuring that the program code is valid and can be correctly interpreted by verification tools.

At step 1504, if no syntax errors are identified through the verification process, then the method 1300 ends. On the other hand, if one or more syntax errors are identified, then the method 1300 continues to step 1506, where the code generator 146 generates a prompt that includes code, syntax errors, and improvement knowledge examples. In some embodiments, the prompt at each iteration of syntax correction indicates error(s) identified at a previous iteration and asks the language model to analyze the error(s) and re-generate the code to fix the error(s), and the prompt also includes the improvement knowledge examples to assist the language model in re-generating the code. In some embodiments, the prompt can have the format of the prompt 1100 described above in conjunction with FIG. 11.

At step 1508, the code generator 146 prompts the language model using the generated prompt to generate updated code. Then, the method 1300 returns to step 1504, where the code generator 146 again verifies the generated code using the code verification tool 1002.

In sum, techniques are disclosed for generating text, such as program code, from natural language instructions. In some embodiments, a code generator application implements a multi-agent framework that uses an experience retrieval agent, an adaptive learning agent, and a syntax correction agent to translate natural language instructions that are received as input into program code. The experience retrieval agent retrieves, from an experience data set, experience examples of translating natural language experiences into code that are relevant to the input natural language instructions. The adaptive learning agent extracts examples of improvement knowledge, generated through self-learning, that are relevant to the input natural language instructions. The code generator generates a prompt that includes the input natural language instructions, the experience examples, and the improvement knowledge examples into a language model. Given such a prompt, the language model generates program code. The syntax correction agent uses a code verification tool to check the generated code for syntactic correctness, and the syntax correction agent prompts the language model to re-generate the code when syntax errors are identified.

A training application uses the adaptive learning agent to generate an improvement knowledge data set, from which improvement knowledge examples can be extracted during code generation. For each pair of natural language instructions and corresponding reference code from a training data set, the adaptive learning agent iteratively prompts a language model to generate code according to the natural language instructions. At each iteration, the adaptive learning agent compares the generated code with the reference code to identify functional and/or syntactic errors. Then, the adaptive learning agent prompts the language model to reflect on the errors, if any, and generate improvement knowledge that includes one or more rules for more accurately generating code for the natural language instructions. The iteration process repeats until the language model generates code that is syntactically correct and functionally identical to the reference code or a maximum number of iterations is reached, after which the latest improvement knowledge is saved in the improvement knowledge data.

At least one technical advantage of the disclosed techniques relative to the prior art is that improvement knowledge is self-learned for use in generating text, such as program code. When program code is generated, the disclosed techniques automatically verify and correct errors in the program code. Accordingly, more accurate text, including program code, can be generated for an input natural language instruction relative to what can be generated using prior art approaches. These technical advantages represent one or more technological improvements over prior art approaches.
1. In some embodiments, a computer-implemented method for generating program code comprises receiving a first natural language instruction, extracting, from an improvement knowledge data set based on the first natural language instruction, one or more first improvement knowledge examples, wherein each improvement knowledge example included in the one or more first improvement knowledge examples comprises one or more learned rules for generating program code, and generating, via a trained language model, first program code based on the first natural language instruction and the one or more first improvement knowledge examples.
2. The computer-implemented method of clause 1, further comprising correcting, using the trained language model, one or more syntax errors in the first program code to generate second program code.
3. The computer-implemented method of clauses 1 or 2, wherein extracting the one or more first improvement knowledge examples is performed by a first agent, and correcting the one or more syntax errors is performed by a second agent.
4. The computer-implemented method of any of clauses 1-3, wherein correcting the one or more syntax errors comprises generating a prompt that includes the first natural language instruction, the first program code, a description of the one or more syntax errors, and the one or more first improvement knowledge examples, and prompting the trained language model using the prompt to generate the second program code.
5. The computer-implemented method of any of clauses 1-4, wherein extracting the one or more first improvement knowledge examples comprises generating a first embedding based on the first natural language instruction, performing an embedding search based on the first embedding and a set of second embeddings associated with a set of second natural language instructions stored in the improvement knowledge data set to retrieve one or more second improvement knowledge examples associated with one or more second natural language instructions included in the set of second natural language instructions, and selecting the one or more first improvement knowledge examples from the one or more second improvement knowledge examples using the trained language model.
6. The computer-implemented method of any of clauses 1-5, wherein generating the first program code comprises generating a prompt that comprises the one or more first natural language instructions and the one or more first improvement knowledge examples, and prompting the trained language model using the prompt to generate the first program code.
7. The computer-implemented method of any of clauses 1-6, further comprising generating first improvement knowledge based on the first natural language instruction, the first program code, and at least one syntax and/or functional error in the first program code, and storing the first improvement knowledge in the improvement knowledge data set.
8. The computer-implemented method of any of clauses 1-7, wherein

generating the first improvement knowledge comprises prompting the trained language model to reflect on the at least one syntax and/or functional error in the first program code.
9. The computer-implemented method of any of clauses 1-8, further comprising retrieving one or more experience examples of translating one or more second natural language instructions to one or more second program code, wherein generating the first program code is further based on the one or more experience examples.

10. The computer-implemented method of any of clauses 1-9, wherein the first program code includes one or more SystemVerilog assertions.
11. In some embodiments, one or more non-transitory computer-readable media store instructions that, when executed by at least one processor, cause the at least one processor to perform the steps of receiving a first natural language instruction, extracting, from an improvement knowledge data set based on the first natural language instruction, one or more first improvement knowledge examples, wherein each improvement knowledge example included in the one or more first improvement knowledge examples comprises one or more learned rules for generating program code, and generating, via a trained language model, first program code based on the first natural language instruction and the one or more first improvement knowledge examples.
12. The one or more non-transitory computer-readable media of clause 11, wherein the instructions, when executed by the at least one processor, further cause the at least one processor to perform the step of correcting, using the trained language model, one or more syntax errors in the first program code to generate second program code.
13. The one or more non-transitory computer-readable media of clauses 11 or 12, wherein extracting the one or more first improvement knowledge examples is performed by a first agent, and correcting the one or more syntax errors is performed by a second agent.
14. The one or more non-transitory computer-readable media of any of clauses 11-13, wherein correcting the one or more syntax errors comprises generating a prompt that includes the first natural language instruction, the first program code, a description of the one or more syntax errors, and the one or more first improvement knowledge examples, and prompting the trained language model using the prompt to generate the second program code.
15. The one or more non-transitory computer-readable media of any of clauses 11-14, wherein extracting the one or more first improvement knowledge examples comprises generating a first embedding based on the first natural language instruction, performing an embedding search based on the first embedding and a set of second embeddings associated with a set of second natural language instructions stored in the improvement knowledge data set to retrieve one or more second improvement knowledge examples associated with one or more second natural language instructions included in the set of second natural language instructions, and selecting the one or more first improvement knowledge examples from the one or more second improvement knowledge examples using the trained language model.
16. The one or more non-transitory computer-readable media of any of clauses 11-15, wherein generating the first program code comprises generating a prompt that includes the one or more first natural language instructions and the one or more first improvement knowledge examples, and prompting the trained language model using the prompt to generate the first program code.
17. The one or more non-transitory computer-readable media of any of clauses 11-16, wherein the instructions, when executed by the at least one processor, further cause the at least one processor to perform the steps of generating first improvement knowledge based on a second natural language instruction, second program code, and at least one functional or syntax error in the second program code, and storing the first improvement knowledge in the improvement knowledge data set.
18. The one or more non-transitory computer-readable media of any of clauses 11-17, wherein generating the first improvement knowledge comprises prompting the trained language model to reflect on the at least one functional or syntax error in the second program code.
19. The one or more non-transitory computer-readable media of any of clauses 11-18, wherein the trained language model comprises a trained large language model (LLM).
20. In some embodiments, a system comprises a memory storing instructions, and one or more processors, that when executing the instructions, are configured to perform the steps of receiving a natural language instruction, extracting, from an improvement knowledge data set based on the natural language instruction, one or more improvement knowledge examples, wherein each improvement knowledge example included in the one or more improvement knowledge examples comprises one or more learned rules for generating program code, and generating, via a trained language model, program code based on the natural language instruction and the one or more improvement knowledge examples.
1. In some embodiments, a computer-implemented method for generating text comprises generating first improvement knowledge based on reflection, by a trained machine learning model, on one or more errors in first text generated from a first natural language instruction, storing the first improvement knowledge in an improvement knowledge data set, and generating second text based on a second natural language instruction and one or more examples of improvement knowledge extracted from the improvement knowledge data set.
2. The computer-implemented method of clause 1, wherein the first text comprises program code, and the one or more errors include one or more syntax errors.
3. The computer-implemented method of clauses 1 or 2, wherein the first text comprises program code, and wherein the one or more errors include one or more functional differences between the program code and reference program code associated with the first natural language instruction.
4. The computer-implemented method of any of clauses 1-3, further comprising processing the first natural language instruction using the trained machine learning model to generate the first text.

5. The computer-implemented method of any of clauses 1-4, further comprising processing the first natural language instruction using the trained machine learning model to generate third text, generating second improvement knowledge based on reflection, by the trained machine learning model, on one or more other errors in the third text, and processing the first natural language instruction and the second improvement knowledge using the trained machine learning model to generate the first text.
6. The computer-implemented method of any of clauses 1-5, wherein generating the first improvement knowledge comprises inputting, into the trained machine learning model, a prompt that instructs the trained machine learning model to reflect upon differences between the first text and reference text associated with the first natural language instruction and to provide one or more improvement suggestions.
7. The computer-implemented method of any of clauses 1-6, wherein the prompt comprises one or more example improvement suggestions.
8. The computer-implemented method of any of clauses 1-7, wherein generating the first improvement knowledge comprises inputting, into the trained machine learning model, a prompt that includes the first natural language instruction, the first text, and an indication of the one or more errors.
9. The computer-implemented method of any of clauses 1-8, wherein the second text comprises program code, and the method further comprises performing one or more operations to correct one or more errors in the program code.
10. The computer-implemented method of any of clauses 1-9, wherein the second text comprises one or more SystemVerilog assertions.
11. In some embodiments, one or more non-transitory computer-readable media store instructions that, when executed by at least one processor, cause the at least one processor to perform the steps of generating first improvement knowledge based on reflection, by a trained machine learning model, on one or more errors in first text generated from a first natural language instruction, storing the first improvement knowledge in an improvement knowledge data set, and generating second text based on a second natural language instruction and one or more examples of improvement knowledge extracted from the improvement knowledge data set.
12. The one or more non-transitory computer-readable media of clause 11, wherein the first text comprises program code, and the one or more errors include one or more syntax errors.
13. The one or more non-transitory computer-readable media of clauses 11 or 12, wherein the first text comprises program code, and wherein the one or more errors include one or more functional differences between the program code and reference program code associated with the first natural language instruction.
14. The one or more non-transitory computer-readable media of any of clauses 11-13, wherein the instructions, when executed by the at least one processor, cause the at least one processor to perform the steps of processing the first natural language instruction using the trained machine learning model to generate third text, generating second improvement knowledge based on reflection, by the trained machine learning model, on one or more other errors in the third text, and processing the first natural language instruction and the second improvement knowledge using the trained machine learning model to generate the first text.
15. The one or more non-transitory computer-readable media of any of clauses 11-14, wherein generating the first improvement knowledge comprises inputting, into the trained machine learning model, a prompt that instructs the trained machine learning model to reflect upon differences between the first text and reference text associated with the first natural language instruction and to provide one or more improvement suggestions.
16. The one or more non-transitory computer-readable media of any of clauses 11-15, wherein generating the first improvement knowledge comprises inputting, into the trained machine learning model, a prompt that includes the first natural language instruction, the first text, and an indication of the one or more errors.
17. The one or more non-transitory computer-readable media of any of clauses 11-16, wherein the first text comprises first program code, and the second text comprises second program code.
18. The one or more non-transitory computer-readable media of any of clauses 11-17, wherein the second text is generated using the trained machine learning model.
19. The one or more non-transitory computer-readable media of any of clauses 11-18, wherein generating the first improvement knowledge is performed using a first agent, and generating the second text is performed using at least a second agent.
20. In some embodiments, a system comprises a memory storing instructions, and one or more processors, that when executing the instructions, are configured to perform the steps of generating first improvement knowledge based on reflection, by a trained machine learning model, on one or more errors in first text generated from a first natural language instruction, storing the first improvement knowledge in an improvement knowledge data set, and generating second text based on a second natural language instruction and one or more examples of improvement knowledge extracted from the improvement knowledge data set.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

We claim:

1. A computer-implemented method for generating text, the method comprising:
generating first improvement knowledge based on reflection, by a trained machine learning model, on one or more errors in first text generated from a first natural language instruction;
storing the first improvement knowledge in an improvement knowledge data set; and
generating second text based on a second natural language instruction and one or more examples of improvement knowledge extracted from the improvement knowledge data set.

2. The computer-implemented method of claim 1, wherein the first text comprises program code, and the one or more errors include one or more syntax errors.

3. The computer-implemented method of claim 1, wherein the first text comprises program code, and wherein the one or more errors include one or more functional differences between the program code and reference program code associated with the first natural language instruction.

4. The computer-implemented method of claim 1, further comprising processing the first natural language instruction using the trained machine learning model to generate the first text.

5. The computer-implemented method of claim 1, further comprising:
processing the first natural language instruction using the trained machine learning model to generate third text;
generating second improvement knowledge based on reflection, by the trained machine learning model, on one or more other errors in the third text; and
processing the first natural language instruction and the second improvement knowledge using the trained machine learning model to generate the first text.

6. The computer-implemented method of claim 1, wherein generating the first improvement knowledge comprises inputting, into the trained machine learning model, a prompt that instructs the trained machine learning model to reflect upon differences between the first text and reference text associated with the first natural language instruction and to provide one or more improvement suggestions.

7. The computer-implemented method of claim 6, wherein the prompt comprises one or more example improvement suggestions.

8. The computer-implemented method of claim 1, wherein generating the first improvement knowledge comprises inputting, into the trained machine learning model, a prompt that includes the first natural language instruction, the first text, and an indication of the one or more errors.

9. The computer-implemented method of claim 1, wherein the second text comprises program code, and the method further comprises performing one or more operations to correct one or more errors in the program code.

10. The computer-implemented method of claim 1, wherein the second text comprises one or more SystemVerilog assertions.

11. One or more non-transitory computer-readable media storing instructions that, when executed by at least one processor, cause the at least one processor to perform the steps of:
generating first improvement knowledge based on reflection, by a trained machine learning model, on one or more errors in first text generated from a first natural language instruction;
storing the first improvement knowledge in an improvement knowledge data set; and
generating second text based on a second natural language instruction and one or more examples of improvement knowledge extracted from the improvement knowledge data set.

12. The one or more non-transitory computer-readable media of claim 11, wherein the first text comprises program code, and the one or more errors include one or more syntax errors.

13. The one or more non-transitory computer-readable media of claim 11, wherein the first text comprises program code, and wherein the one or more errors include one or more functional differences between the program code and reference program code associated with the first natural language instruction.

14. The one or more non-transitory computer-readable media of claim 11, wherein the instructions, when executed by the at least one processor, cause the at least one processor to perform the steps of:
processing the first natural language instruction using the trained machine learning model to generate third text;
generating second improvement knowledge based on reflection, by the trained machine learning model, on one or more other errors in the third text; and
processing the first natural language instruction and the second improvement knowledge using the trained machine learning model to generate the first text.

15. The one or more non-transitory computer-readable media of claim 11, wherein generating the first improvement knowledge comprises inputting, into the trained machine learning model, a prompt that instructs the trained machine learning model to reflect upon differences between the first text and reference text associated with the first natural language instruction and to provide one or more improvement suggestions.

16. The one or more non-transitory computer-readable media of claim 11, wherein generating the first improvement knowledge comprises inputting, into the trained machine learning model, a prompt that includes the first natural language instruction, the first text, and an indication of the one or more errors.

17. The one or more non-transitory computer-readable media of claim 11, wherein the first text comprises first program code, and the second text comprises second program code.

18. The one or more non-transitory computer-readable media of claim 11, wherein the second text is generated using the trained machine learning model.

19. The one or more non-transitory computer-readable media of claim 11, wherein generating the first improvement knowledge is performed using a first agent, and generating the second text is performed using at least a second agent.

20. A system, comprising:
a memory storing instructions; and
one or more processors, that when executing the instructions, are configured to perform the steps of:
generating first improvement knowledge based on reflection, by a trained machine learning model, on one or more errors in first text generated from a first natural language instruction,
storing the first improvement knowledge in an improvement knowledge data set, and
generating second text based on a second natural language instruction and one or more examples of improvement knowledge extracted from the improvement knowledge data set.
